(19) United States
(12) Patent Application Publication
(10) Pub. No.: US 2015/0010669 A1
(43) Pub. Date: Jan. 8, 2015

(54) PET FOOD PRODUCT AND METHOD FOR FEEDING PET FOOD TO PET

(71) Applicant: NISSHIN PETFOOD INC., TOKYO (JP)

(72) Inventor: Seiji KIMURA, Tochigi (JP)

(73) Assignee: NISSHIN PETFOOD INC., TOKYO (JP)

(21) Appl. No.: 14/293,331

(22) Filed: Jun. 2, 2014

(30) Foreign Application Priority Data
Jul. 3, 2013 (JP) 2013-139477

(51) Int. Cl. A23K 1/18; A23K 1/16

(52) U.S. Cl. CPC A23K 1/1846; A23K 1/1646; A23K 1/164; A23K 1/1631
USPC 426/2; 426/658

(57) ABSTRACT

A pet food product having an excellent antiobesity effect and a method of feeding a pet pet food. The pet food product includes two kinds of pet food different in composition, pet food A and pet food B, in a manner such that they are not mixed with each other. Pet food A contains 30 to 60 mass % carbohydrate, 20 to 35 mass % protein, and 10 to 25 mass % fat. Pet food B contains 50 to 75 mass % carbohydrate, 15 to 30 mass % protein, and 5 to 15 mass % fat. Pet food A and pet food B have a relationship such that after at least three hours from feeding a pet one of them, the other is fed to the pet. Pet food product has a pet food A to B content ratio of 1 to 2:1.

### BACKGROUND OF INVENTION

1. Technical Field

This invention relates to a pet food product for domesticated mammals (pets), such as dogs and cats, and a method for feeding pet food to a pet. In particular, it relates to a pet food product having an excellent antiobesity effect and a method of feeding pet food to a pet.

2. Background Art

The pet population has ever been increasing in line with the recent popularity of pets. In accordance with this tendency, there has been a growing problem of pet obesity due to lack of exercise, nutrient excess, and the like. Obesity is a medical condition in which fat tissue has accumulated to a degree more than usual as a result of excess energy intake relative to energy expenditure. Obesity, excessive body fat accumulation, can cause various diseases in pets, such as diabetes, hypertension, hyperlipidemia, arteriosclerosis, and so on. Hence, studies on means for decreasing obesity in pets have been conducted from many aspects, and a variety of treatments, including dietary therapy, exercise therapy, and pharmacotherapy, have been developed and implemented. Because hyperlipidemia involving abnormally elevated cholesterol and triglyceride levels in blood is a risk factor for the acceleration of arteriosclerosis and the development of various diseases, to maintain or reduce serum lipid levels of a pet at or to normal levels is very important for pet health care.

With regard to pet diet and health care, patent literatures 1 and 2 below describe methodology for determining specific target values of protein, fat, and carbohydrate consumption for individual pets. Once the target values are determined, a customized foodstuff or dietary regime equivalent to the target macronutrient ratio can be formulated for each individual animal. Patent literature 1 discloses a multi-component foodstuff comprising two or more compartmentalised food compositions, of which at least two compositions differ in contents of at least two of fat, protein, and carbohydrate.

Patent literature 3 below describes a nutritional supplement for humans formulated based on chrononutrition. Chrononutrition is a science that studies nutrition based on chronobiology. In particular, the relation between circadian clock gene and diet is now attracting attention. The nutritional supplement described in patent literature 3 comprises a first portion and a second portion. The portions are each dosed with a chronologically appropriate supplemental nutrient and have different dosages from each other. In one embodiment, the first portion can include nutrients appropriate for an individual's morning dosage, and the second portion can be dosed with nutrients appropriate for an evening or night time dosage.

### CITATION LIST

### Patent Literature

Patent literature 1: JP 2006-510376A

Patent literature 2: JP 2006-510377A

Patent literature 3: JP H11-505723A

### SUMMARY OF INVENTION

### Technical Problem

An object of the invention is to provide a pet food product that inhibits accumulation of body fat and exhibits an excellent antiobesity effect and a method for feeding pet food to a pet.

### Solution to Problem

The inventors of the invention chrononutritionally conducted extensive investigations on prevention of obesity in pets and found, as a result, that an inhibitory effect on elevation of blood triglyceride level in a pet after pet food intake is obtained by adopting a feeding cycle of pet food in which one of two specific kinds of pet food having different compositions is given to a pet and, after elapse of at least three hours, the other pet food is given to the pet.

The invention has been reached based on this finding and provides a pet food product. The pet food product of the invention includes two kinds of pet food which are different from each other in composition, designated as pet food A and pet food B, in a manner such that they are not mixed with each other. Pet food A contains 30 to 60 mass % carbohydrate, 20 to 35 mass % protein, and 10 to 25 mass % fat. Pet food B contains 50 to 75 mass % carbohydrate, 15 to 30 mass % protein, and 5 to 15 mass % fat. Pet food A and pet food B have a relationship such that after at least three hours from feeding a pet one of them, the other is fed to the pet. The pet food product has a pet food A to B content ratio of 1 to 2:1.

Based on the above finding, the invention also provides a method for feeding pet food to a pet which includes feeding a pet one of pet foods A and B which are different in composition as indicated below and, after at least three hours from the feeding, feeding the other pet food. The mass ratio of the amount of pet food A to be fed to the amount of pet food B to be fed is 1 to 2:1.

Pet food A: 30 to 60 mass % carbohydrate, 20 to 35 mass % protein, and 10 to 25 mass % fat.
Pet food B: 50 to 75 mass % carbohydrate, 15 to 30 mass % protein, and 5 to 15 mass % fat.

### Advantageous Effects of Invention

The invention provides effective inhibition on excessive accumulation of body fat while securing intake of nutrients necessary for pet health maintenance. The invention thus brings about good effects on both health maintenance and obesity prevention (diet effect).

### BRIEF DESCRIPTION OF DRAWINGS

FIG. 1(a) and FIG. 1(b) are each a graph showing the change in blood triglyceride level after feeding a pet (dog) the pet (dog) food product of Example.

FIG. 2(a) and FIG. 2(b) are each a graph showing the change in free fatty acid level in blood after feeding a pet (dog) the pet (dog) food of Example.

### DESCRIPTION OF EMBODIMENTS

The pet food product of the invention includes two kinds of pet food, i.e., pet food A and pet food B, having different compositions in a manner such that they are not mixed with each other. That is, pet foods A and B of the pet food product of the invention are independent of each other and are designed to be taken out separately from each other. In one preferred embodiment, the pet food product of the invention has a container in which pet foods A and B are separately packaged. The container is not particularly limited as long as it is capable of holding pet food and may be a bag or a box. The individual packaging form of pet foods A and B is not particularly limited, either. For example, the container for holding pet foods A and B may include a sub-container for pet food A and another sub-container for pet food B.

Pet food A contains 30 to 60 mass % carbohydrate, 20 to 35 mass % protein, and 10 to 25 mass % fat. Pet food A preferably has a carbohydrate content of 35 to 55 mass %, more preferably 40 to 50 mass %, a protein content of 22 to 28 mass %, more preferably 24 to 26 mass %, and a fat content of 12 to 22 mass %, more preferably 14 to 20 mass %.

Pet food B contains 50 to 75 mass % carbohydrate, 15 to 30 mass % protein, and 5 to 15 mass % fat. Pet food B preferably has a carbohydrate content of 47 to 70 mass %, more preferably 50 to 60 mass %, a protein content of 17 to 28 mass %, more preferably 18 to 22 mass %, and a fat content of 7 to 13 mass %, more preferably 8 to 12 mass %.

The carbohydrate, protein, and fat contents in pet food are measured in accordance with the method described in “Enforcement Regulations for the Fair Competition Code Concerning Labeling of Pet Food” by Pet Food Fair Trade Association, Japan.

It is only necessary for pet foods A and B to satisfy the above specified respective content range of the three components (carbohydrate, protein, and fat) and may contain other ingredients in addition to the three ingredients. Raw materials of the ingredients are not particularly limited.

Raw materials of pet foods A and B may be chosen from those conventionally used in this type of pet food with no particular limitation. Examples of useful raw materials include animal protein raw materials, such as chicken, turkey, beef, pork, horse meat, mutton, fish, egg products, and milk products; plant protein raw materials, such as soy protein and potato protein; animal fats and oils, such as fish oil; plant fats and oils, such as corn oil, salad oil, soybean oil, sesame oil, cotton seed oil, rape seed oil, linseed oil, safflower oil, olive oil, and sunflower oil; carbohydrate raw materials, such as root and tuber crops, ground corn, and corn flour; nutritional supplements or health builders, such as vitamins, minerals, amino acids, amylase inhibitors, lipase inhibitors, wheat gluten hydrolysate, chondroitin sulfate, polyphenol-containing materials, lactic bacteria, γ-aminobutyric acid (GABA), coenzyme Q10, and fibrous components; seasonings, such as salt, sugar, and sodium glutamate; spices, such as basil, clove, and rosemary; flavors, such as fish extract; thickeners, such as gums; gelling agents; and fiber components. These materials may be used either individually or in combination of at least two kinds thereof.

Pet foods A and B are not limited in moisture content. That is, pet foods A and B may be dry, semi-moist, or wet. Dry food has a moisture content of about 10 mass % at the most, and wet food has a moisture content of around 80 mass %. Semi-moist food has a moisture content intermediate between dry and wet types (about 25 to about 75 mass %). Pet foods A and B are preferably of dry or semi-moist type in terms of productivity, handling, and nutrition.

Pet foods A and B which are dry or semi-moist are not particularly limited in shape and may be formulated into pellets having the same shapes as conventional dry or semi-moist pet food. Examples of the shape of the pellets include a cylindrical shape, a bar shape, a doughnut shape, a star shape, a dog-bone shape, a comma shape, a flat-round shape, a spherical shape, an oval shape, and a square shape. The pellets may have any size appropriate to the kind and age of a pet to be fed.

The process for preparing pet foods A and B is not particularly limited. Pet foods A and B may be prepared by any conventional process for producing pet food using, for example, an extruder, an injection molding machine, or a compression molding machine.

Pet foods A and B are suitable as feed for small domesticated mammals, such as dogs and cats, particularly as pet food for dogs (dog food).

Pet foods A and B of the pet food product of the invention have a relationship such that, after at least three hours from feeding a pet one of them, the other is fed to the pet. According to the method of use of the pet food product of the invention, i.e., the method for feeding pet food to a pet according to the invention, one of pet foods A and B is fed to a pet, and it is necessary that the other be fed after at least 3 hours, preferably 5 hours or more, more preferably 7 to 12 hours, from the preceding feeding operation. In the case when the cycle of feeding pet foods A and B is repeated (when pet food A and pet food B are given to a pet alternately for multiple times), one feeding cycle completes by feeding a pet pet food A followed by pet food B or vice versa with a time interval of at least 3 hours between feeding operations. The time interval may be fixed or variable from cycle to cycle. For instance, when feeding starts with, e.g., pet food A, pet food B is given to the pet after elapse of 3 hours or more from the first feeding, and thereafter the pet is given pet food A and pet food B in that order repeatedly with a time interval of at least 3 hours.

The method of use of the pet food product of the invention, i.e., the method for feeding according to the invention is characterized by not only the above described feeding cycle composed of alternate use of pet foods A and B but also a mass ratio of the amount of pet food A to be fed to the amount of pet food B to be fed of 1 to 2:1, preferably 1 to 1.5:1, more preferably 1 to 1.2:1. When the feeding cycle using pet foods A and B is consecutively repeated (when pet food A and pet food B are given to a pet alternately for multiple times), it is preferred that the above feeding ratio of pet foods A and B be achieved in every feeding cycle. The pet food product of the invention includes pet foods A and B in a ratio corresponding to the above discussed feeding ratio, i.e., an A to B ratio of 1 to 2:1, preferably 1 to 1.5:1, more preferably 1 to 1.2:1.

The pet food product of the invention inhibits elevation of blood triglyceride levels after eating to produce an excellent antiobesity effect as long as it is fed to a pet according to the aforementioned feeding method.

To further ensure the antiobesity effect of the invention, it is preferred that a time to feed either one of pet foods A and B be between midnight (twelve midnight) and noon (twelve noon) inclusive and that a time to feed the other pet food be between noon (twelve noon) and midnight (twelve midnight) inclusive. It is particularly preferred that either one of pet foods A and B be given between 6 o'clock and 10 o'clock inclusive and the other be given between 17 o'clock and 21 o'clock inclusive.

While the order and time of feeding pet foods A and B are not particularly restricted, it is preferred that pet food A be fed to a pet between midnight and noon, particularly between 6 o'clock and 10 o'clock inclusive and that pet food B be given between noon and midnight, particularly between 17 o'clock and 21 o'clock inclusive, taking the above described preferred compositions of pet foods A and B into consideration. As previously discussed, a particularly preferred composition of pet food A contains 40 to 50 mass % carbohydrate, 24 to 26 mass % protein, and 14 to 20 mass % fat whilst a particularly preferred composition of pet food B contains 50 to 60 mass % carbohydrate, 18 to 22 mass % protein, and 8 to 12 mass % fat. As can be seen, pet food A is richer than pet food B in at least protein and fat. With respect to carbohydrate, the carbohydrate content range of pet food A overlaps with that of pet food B only at 50 mass %, so that pet food A is substantially richer than pet food B in carbohydrate, too. From the viewpoint of inhibitory effect on blood triglyceride level elevation after eating, which leads to prevention of obesity, it is preferred that pet food A having relatively high nutritional value (fat content) be given to a pet between midnight and noon (in the morning) and that pet food B with relatively low nutritional value (fat content) be given between noon and midnight (in the afternoon).

### EXAMPLES

The invention will now be illustrated in greater detail with reference to Examples, but it should be understood that the invention is not deemed to be limited thereto.

### Example 1

Dry dog foods A and B were prepared according to the formulations shown in Table 1 below. Specifically, the raw materials in Table 1 were thoroughly mixed using a mixer. The mixture was fed to an extruder, extruded to form self-expanding extrudate, and the expanded extrudate was cut with a cutter into cylindrical pellets of 5 mm in diameter and 10 mm in length, which were dried in a drier to prepare dog foods A and B. The resulting dog foods A and B were separately packaged hermetically in respective retort pouches. The two packages were put in a bag as a packaging container to give a dog food product. The dog food A to dog food B content ratio of the dog food product was 1:1. The carbohydrate, protein, and fat contents of each of dog foods A and B were determined by the methods described above. The results obtained are shown in Table 2 along with the moisture content.

TABLE 1

| Raw Materials (part by mass) | Dog Food A | Dog Food B |
|---|---|---|
| Corn | 400 | 408 |
| Wheat flour | 40 | 400 |
| Soybean meal | 140 | 10 |
| Corn gluten meal | 20 | 20 |
| Chicken meal | 130 | 50 |
| Meat meal | 110 | 30 |
| Chicken liver powder | 10 | 10 |
| Beef tallow | 130 | 35 |
| Edible salt | 10 | 10 |
| Calcium carbonate | 1 | 10 |
| Calcium phosphate | 4 | 10 |
| Vitamin mineral mix | 5 | 7 |
| Total | 1000 | 1000 |

TABLE 2

| Ingredients (mass %) | Dog Food A | Dog Food B |
|---|---|---|
| Carbohydrate | 37.4 | 56.5 |
| Protein | 28.2 | 18.4 |
| Fat | 18.2 | 8.1 |
| Moisture content | 8.0 | 8.0 |

### Test for Evaluating Dog Food Product:

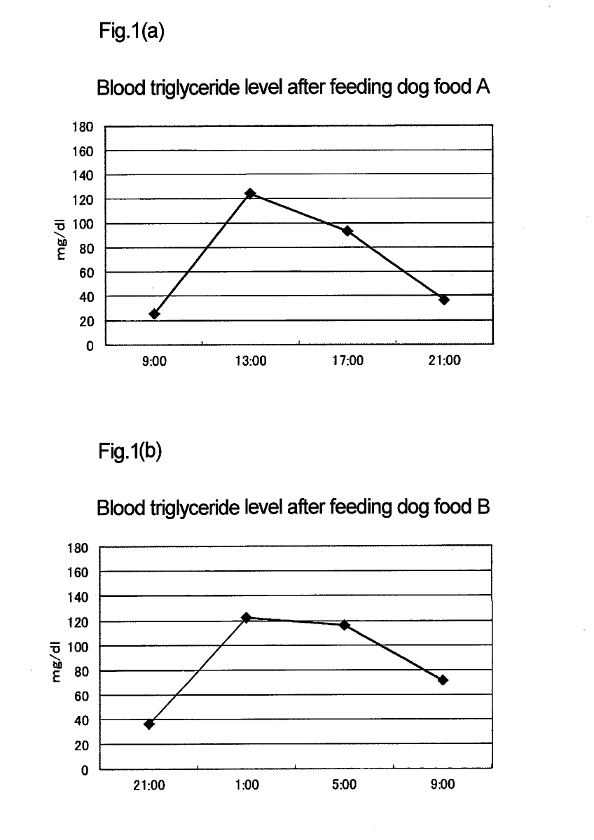

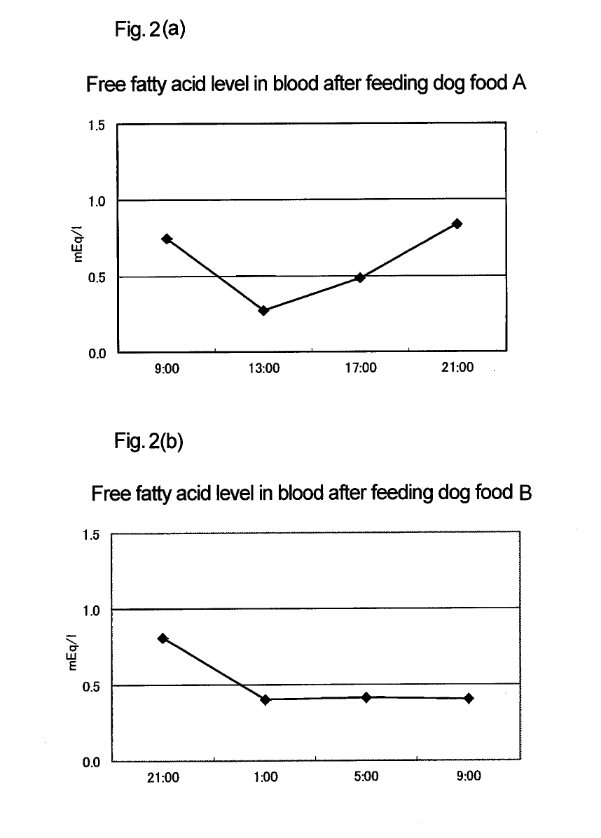

Six 3-year-old female beagle dogs (average body weight: 10 kg) were individually caged. A bowl containing a predetermined amount of dog food was placed in each cage at predetermined feed times, and the dogs were let eat ad lib. The dog food was given twice a day, at 9 o'clock and 21 o'clock. A hundred gram of dog food A was given at 9 o'clock, and a hundred gram of dog food B was given at 21 o'clock. Blood samples were collected from the dogs before feeding dog food A and every 4 hours after feeding dog food A, and serum was separated from each blood sample. “Serum” is a supernatant fluid obtained by leaving the blood in a test tube to stand, a component obtained by removing blood cells and platelets from blood, for the purpose of analyzing blood lipids including triglycerides and free fatty acids. The triglyceride level in serum was determined by an enzymatic method (free glycerol elimination method), and the free fatty acid level in serum was determined by an enzymatic method (UV-END method). The results (averages of measured values) obtained are shown in FIGS. 1 and 2.

FIG. 1 shows the change in blood triglyceride level after feeding the dogs the dog food product of the invention. As shown in FIGS. 1(a) and 1(b), the blood triglyceride level increases after feeding each of dog foods A and B until 4 hours after the feeding as a result of dietary intake of lipid but decreases thereafter. It is seen from these results that accumulation of triglycerides in the body after intake of dog foods A and B is inhibited. Although dog food A is richer in protein and fat than dog food B (see Table 2) and therefore has relatively higher nutritional value (fat content), feeding it between midnight and noon is followed by significant decrease in blood triglyceride level as shown in FIG. 1(a). This is considered to be because fat in the dog body is easily used as energy during these hours of day (in the morning). Thus, feeding a pet pet food A having a relatively high fat content in midnight-to-noon hours is proved effective on the prevention of obesity.

FIG. 2 shows the change in free fatty acid level in blood after feeding the dogs the dog food product of the invention. It is known that fat cells of fat tissue contains an enzyme that catalyzes decomposition of accumulated fat (triglycerides) into free fatty acids as energy source and that, upon being activated, the enzyme breaks down the accumulated fat into free fatty acids, which are delivered by the blood to the liver where they burn to provide energy. Therefore, rise of the free fatty acid level in blood means the acceleration of body fat break down, which will result in prevention of obesity. Although a rise in blood free fatty acid level is not obtained after feeding the dogs dog food B as shown in FIG. 2(b), dog food A with relatively high nutritional value (fat content) brings about a marked increase in blood free fatty acid level after 4 hours have passed from its feeding as shown in FIG. 2(a). Thus, feeding a pet pet food A having a relatively high fat content in midnight-to-noon hours is proved effective on the acceleration of body fat break down and then prevention of obesity.

1. A pet food product comprising pet food A and pet food B in a manner preventing the pet foods A and B from being mixed with each other,
the pet food A comprising 30 to 60 mass % carbohydrate, 20 to 35 mass % protein, and 10 to 25 mass % fat,
the pet food B comprising 50 to 75 mass % carbohydrate, 15 to 30 mass % protein, and 5 to 15 mass % fat,
the pet food A and the pet food B having a relationship such that after at least three hours from feeding a pet one of them, the other is fed to the pet, and
a pet food A to pet food B content ratio being 1 to 2:1.

2. The pet food product according to claim 1, wherein the pet food A and the pet food B are dog food.

3. A method for feeding a pet comprising feeding the pet one of the pet food A comprising 30 to 60 mass % carbohydrate, 20 to 35 mass % protein, and 10 to 25 mass % fat and the pet food B comprising 50 to 75 mass % carbohydrate, 15 to 30 mass % protein, and 5 to 15 mass % fat and, after at least three hours from the feeding, feeding the other pet food,
the mass ratio of the amount of the pet food A to be fed to the amount of the pet food B to be fed being 1 to 2:1.

4. The method for feeding a pet according to claim 3, wherein a time to feed either one of the pet foods A and B is between midnight and noon inclusive, and a time to feed the other pet food is between noon and midnight inclusive.

5. The method for feeding a pet according to claim 3, wherein a time to feed the pet food A is between midnight and noon inclusive, and a time to feed the pet food B is between noon and midnight inclusive.

6. The method for feeding a pet according to claim 4, wherein a time to feed the pet food A is between midnight and noon inclusive, and a time to feed the pet food B is between noon and midnight inclusive.
